(19) United States
(12) Patent Application Publication
(10) Pub. No.: US 2002/0149616 A1
(43) Pub. Date: Oct. 17, 2002

(54) Online system for managing health care benefits

(76) Inventors: Chad Gross, Andover, MN (US); Jane Severson, St. Louis Park, MN (US); Tracy Jones, Minnetonka, MN (US); Diana Esquibel, Pueblo, CO (US)

Correspondence Address: Oppenheimer Wolff & Donnelly LLP, Suite 3300, 45 South Seventh Street, Minneapolis, MN, 55402-1609, US

(21) Appl. No.: 10/034,478

(22) Filed: Dec. 28, 2001

Related U.S. Application Data
(60) Provisional application No. 60/259,555, filed on Jan. 3, 2001.

(51) Int. Cl. G09G 5/00

(52) U.S. Cl. 345/745; 345/741

(57) ABSTRACT

A system for an online health care administration system includes a database, a web server, and a personal computer for the user, connected to the Internet. The browser presents to the user a dynamically generated series of webpages. The content for these webpages is personalized to the user who is logged into the website, and includes information on the benefits package elected by the user/employee. Furthermore, the webpages are personalized based on the benefit package from the employer group to which the user is an employee. In one embodiment, the webpage displays not only content about the plans administrated by the plan administrator, but also links to content about plans or other benefits that are not administered by the plan administrator. In one embodiment, a dynamic profile is created for the user/employee. This dynamic profile is used to allow the user to send secure e-mail to a customer service representative at any point after logging in, without requiring the user to provide further authenticating data.

### CROSS-REFERENCE TO RELATED APPLICATIONS

This application claims the benefit of U.S. Provisional Application No. 60/259,555, filed on Jan. 3, 2001, entitled “Online system and method for managing health care benefits,” which is incorporated herein by reference.

### BACKGROUND OF THE INVENTION

The present invention relates to content provided over the Internet, and particularly to an online system for managing health care benefits.

The costs of health care and other elements of an employee's benefits plan are consistently becoming more expensive. Employers are faced with either accepting the increased costs themselves, passing along the increases to their employees, or a combination of both. For example according to a study by Towers Perrin, it is estimated that employees will see a sharp 13% increase in their health care costs in 2002.

Although the administration of health care plans is not the primary cause of these significant increases, in recent years, companies have turned to outsourcing the administration of the plans as at least part of the solution to contain costs. Since at least one study has found that only about 10% of employers have excellent employee satisfaction with their health plans, health plan administrators are working to increase satisfaction. Plan administrators have discovered that offering telephone or online access to the employee, so that he or she can find an appropriate provider or check the status of a claim, increases the employee's satisfaction with the benefit plans. Such “self-service” programs are the hottest trend in benefits management account to a recent Deloitte & Touche survey. Such programs can indeed help to decrease costs. For example, in the year 2000, when more than 80% of IBM's 140,000 employees used an intranet website to enroll in their health plans, IBM saved about $1 million in administration costs.

A survey by The Hunter Group in year found that employers believe that selfservice websites in which employees can view and manage their benefit plans have “a major impact on both employee satisfaction and the corporate bottom line.” In part, increased satisfaction results from the employees being more engaged in the interactive website rather than the standard set of year-end memos from the human resources department announcing all of the changes to the benefits plans for the upcoming year.

While outsourcing duties to a benefits plan administrator is popular, and while such administrators have developed online tools for employees, the tools are currently suboptimal. Often, the websites offer minimal information. Or they offer too much information and so the employee/user cannot find what he or she is looking for. In yet other systems, the information is so generic that the user must follow-up with a phone call to a customer service representative or to the human resources department for a specific answer. These problems are understandable since an administrator may be handling perhaps 5,000 different benefit plans, with over 150 health care provider networks and 1 million plan members.

### BRIEF SUMMARY OF THE INVENTION

This invention is a system for accessing content from the Internet related to a user/employee's benefits plan. More particularly, the present invention is an online health care administration system for employers who self-fund their benefit plans. In one embodiment, the system includes a database, a web server, and a personal computer for the user, connected to the Internet. On the web server is software and files (such as HTML files) that are used to respond to requests made by a web browser located on the user's computer. The browser presents to the user a dynamically generated series of webpages. The content for these webpages is personalized to the user who is logged into the website, and includes information on the benefits package elected by the user/employee. Furthermore, the webpages are personalized based on the benefit package offered by the employer group to which the user is an employee.

In one embodiment, the webpage displays not only content about the plans administrated by the plan administrator, but also links to content about plans or other benefits that are not administered by the plan administrator. In this way, anything related to the employee/user's benefits is presented to the user in one location. Previously, the user would have needed to contact different departments to find this information.

In one embodiment, a dynamic profile is created for the user/employee. This dynamic profile is used to allow the user to send secure e-mail to a customer service representative at any point after logging in, without requiring the user to provide his or her name, policy number, or other authenticating data.

With the present invention, plan members have access to personalized, timely, health care information from any computer connected to the Internet, 24 hours a day, seven days a week. The user/employees enroll in their plans, review their coverage, find out the status of pending claims, track their deductibles, find providers affiliated with their plan, and research health topics of interest to them from the website. Plan members can also access an online pharmacy for prescription drugs covered by their benefit plan.

The employers enjoy paperless enrollment and eligibility services, immediate access to plan administration and benefit coverage information, as well as online management reporting. Consultants receive online assistance and support to run their businesses effectively.

### BRIEF DESCRIPTION OF THE DRAWINGS

For a more complete understanding of the present invention and its features and advantages, reference is made to the following description taken in conjunction with accompanying drawings, in which:

FIG. 1 is a block diagram of one embodiment of the present invention, illustrating the various functions provided by the website.

FIG. 2 is a block diagram of one embodiment of the present invention, illustrating the consultant portal portion of the invention.

FIG. 3 is a block diagram of one embodiment of the technical architecture of the present invention.

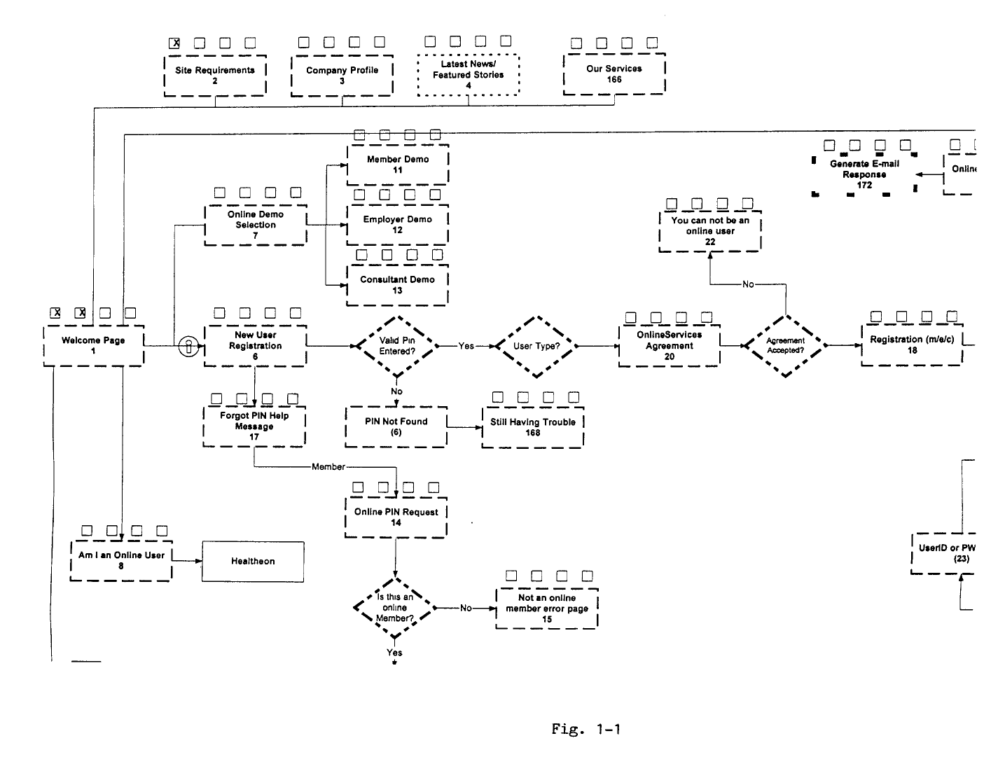

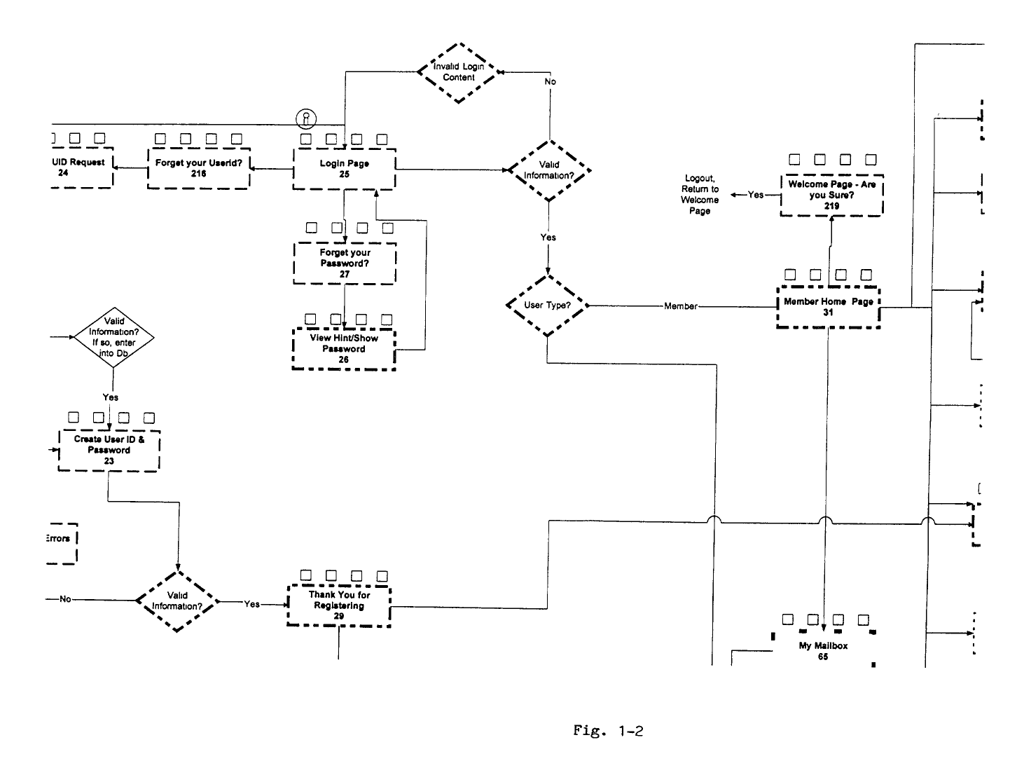

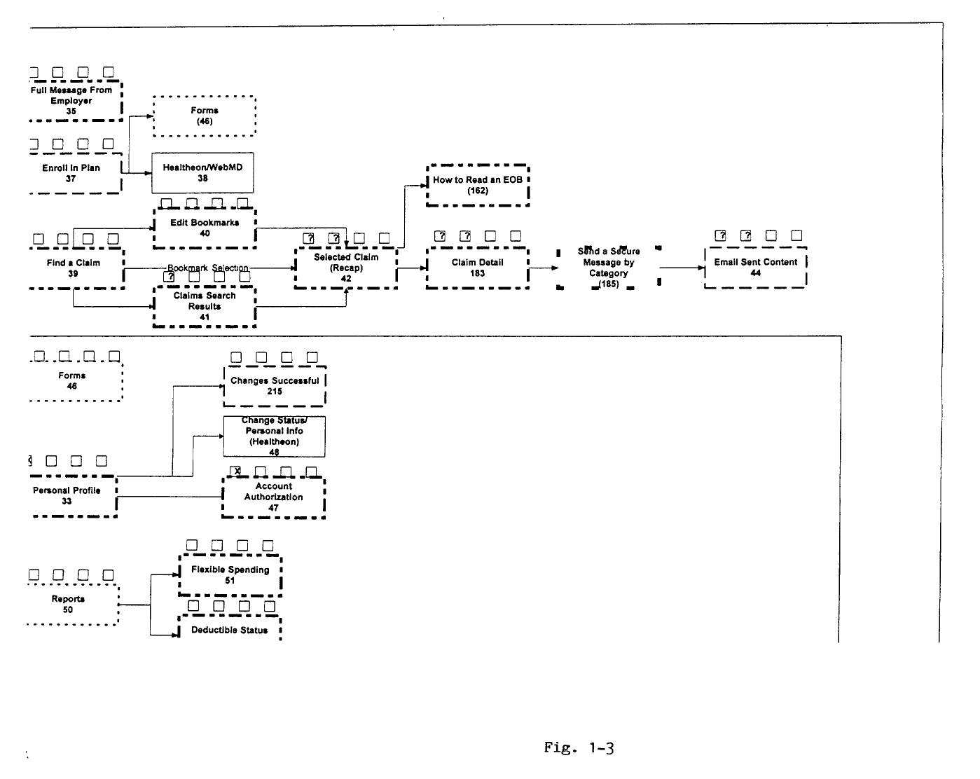

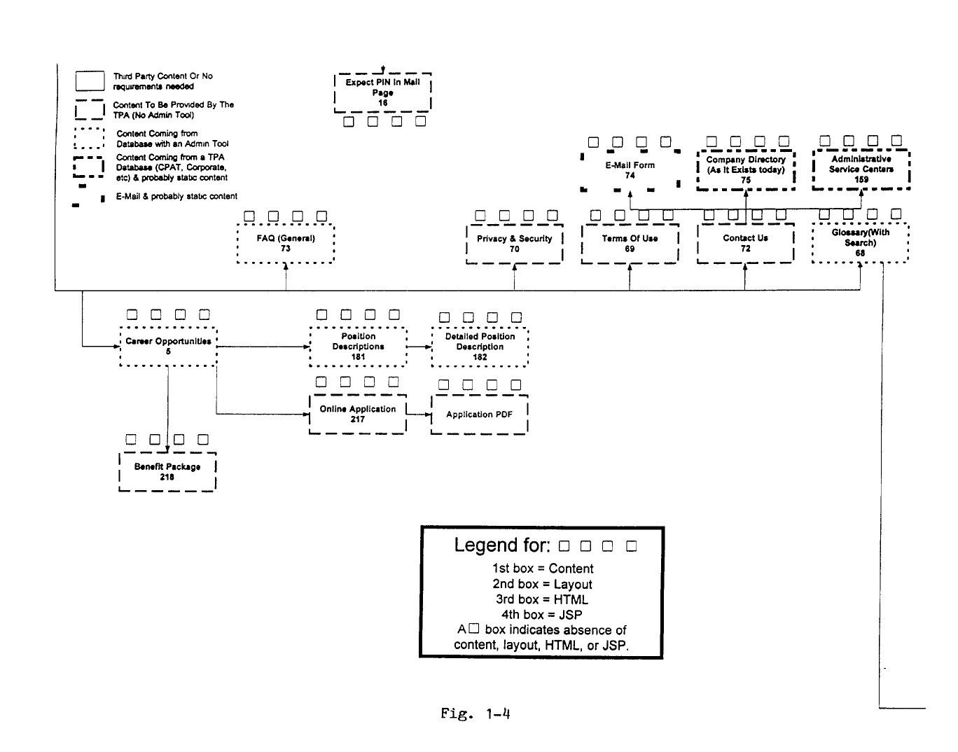

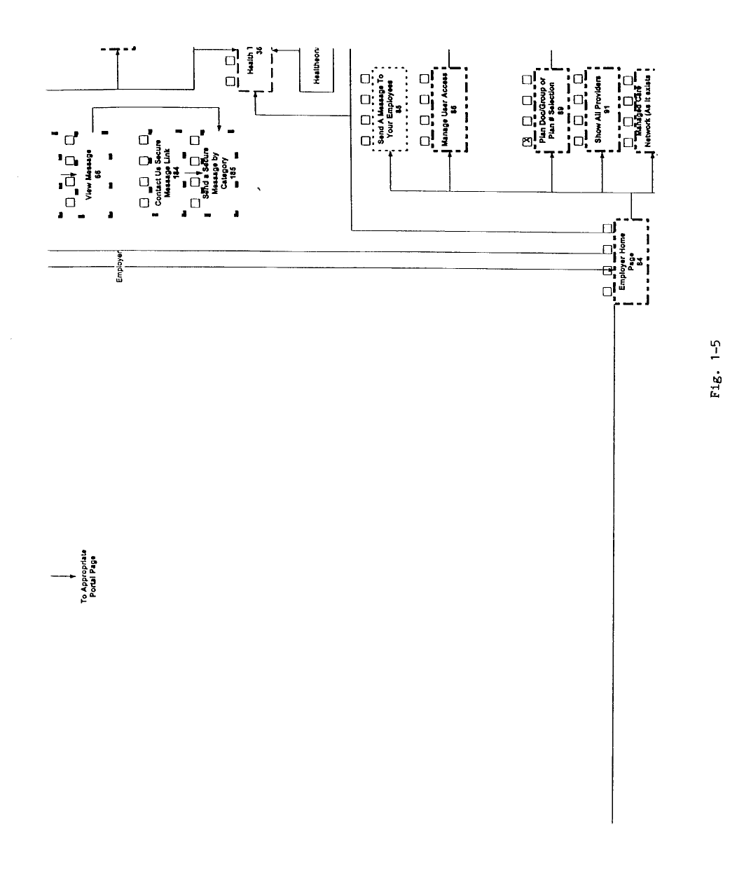

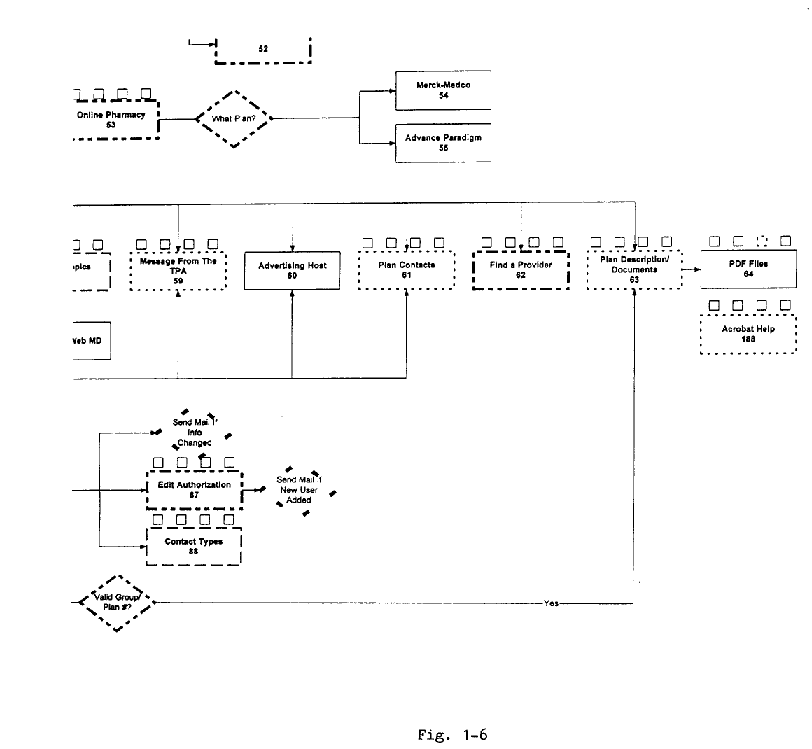

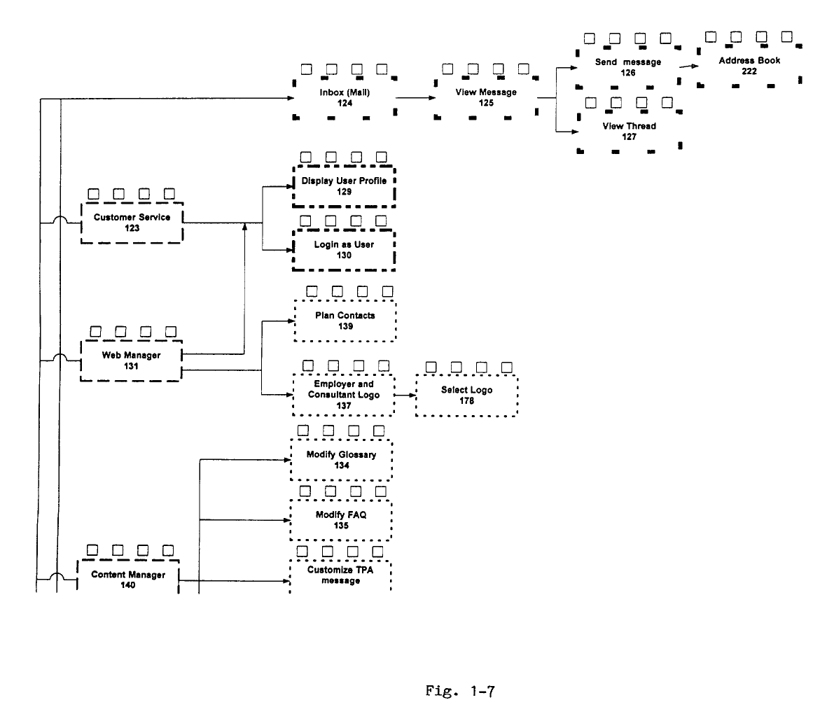

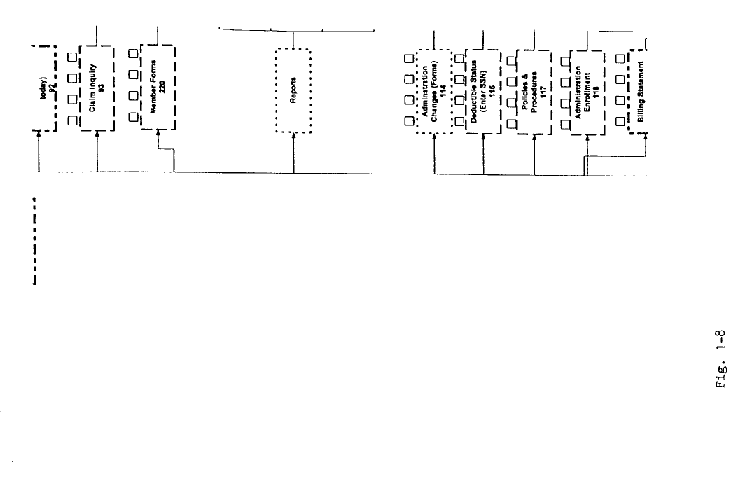

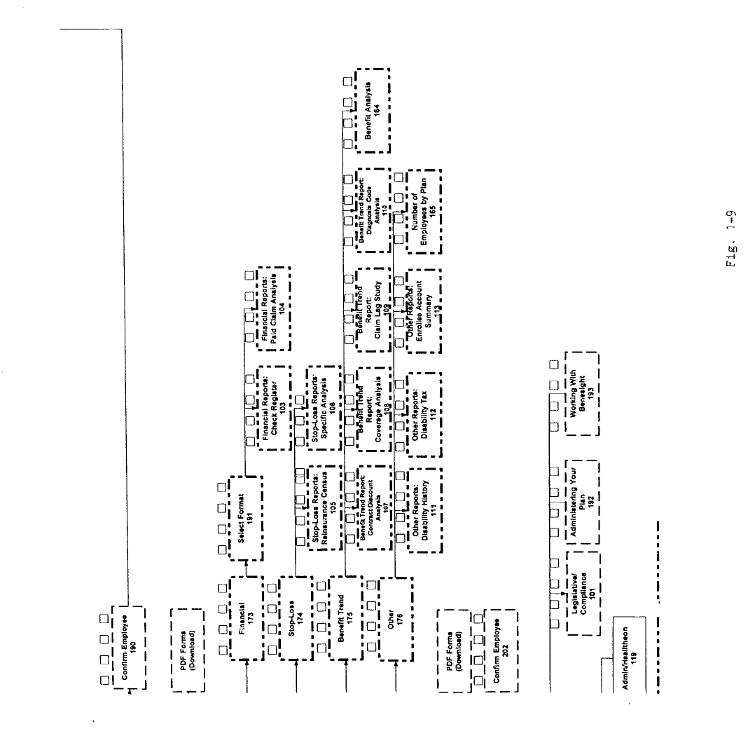

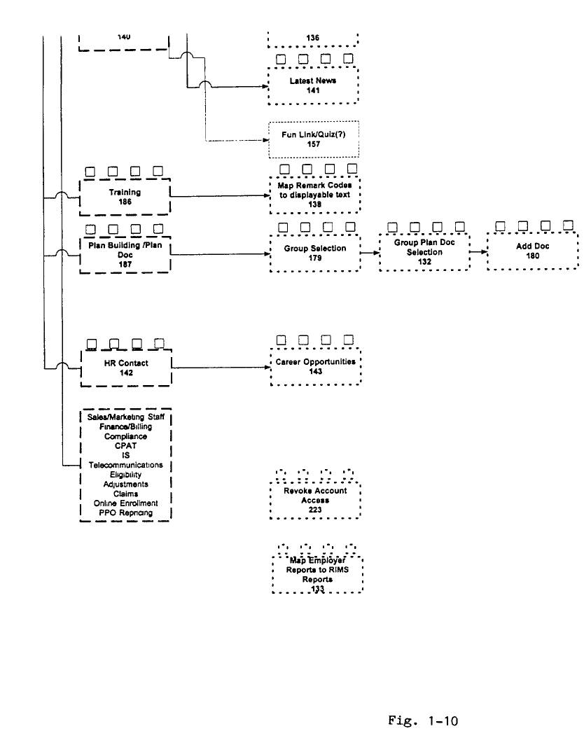

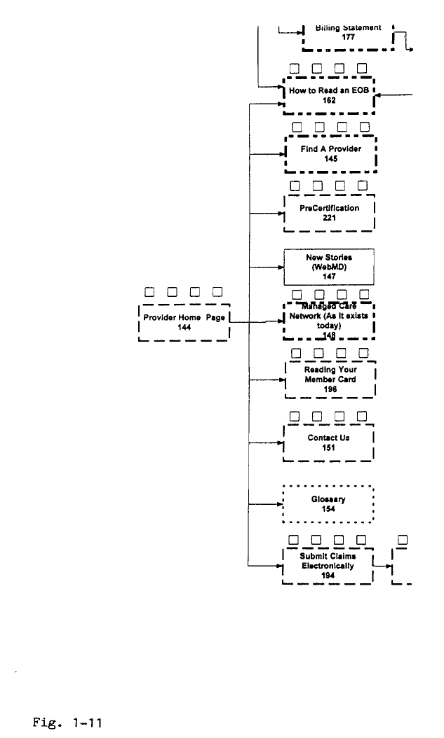

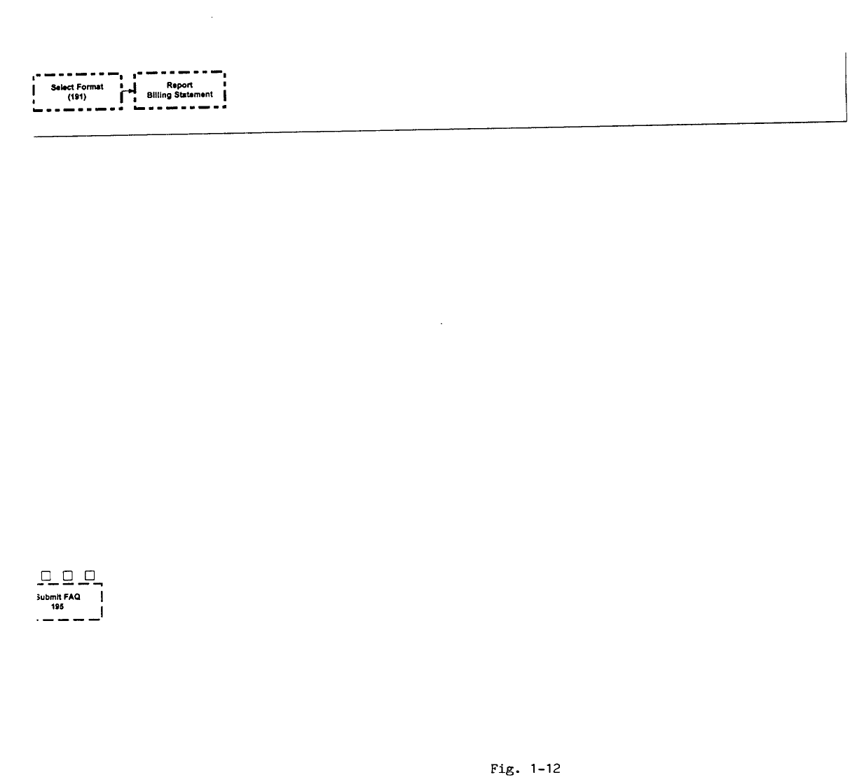

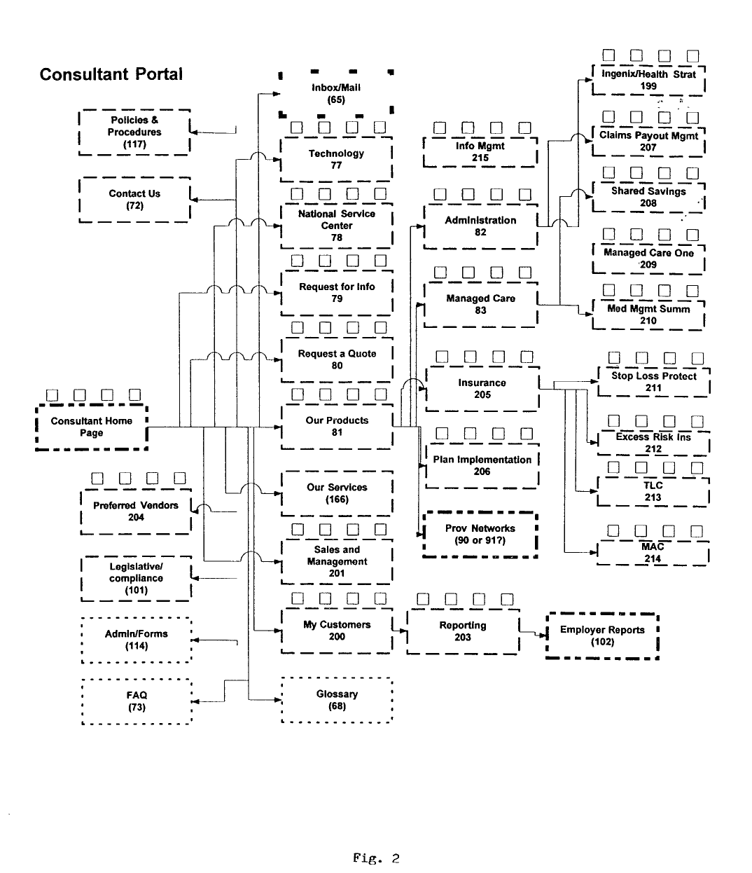

### DETAILED DESCRIPTION OF THE INVENTION

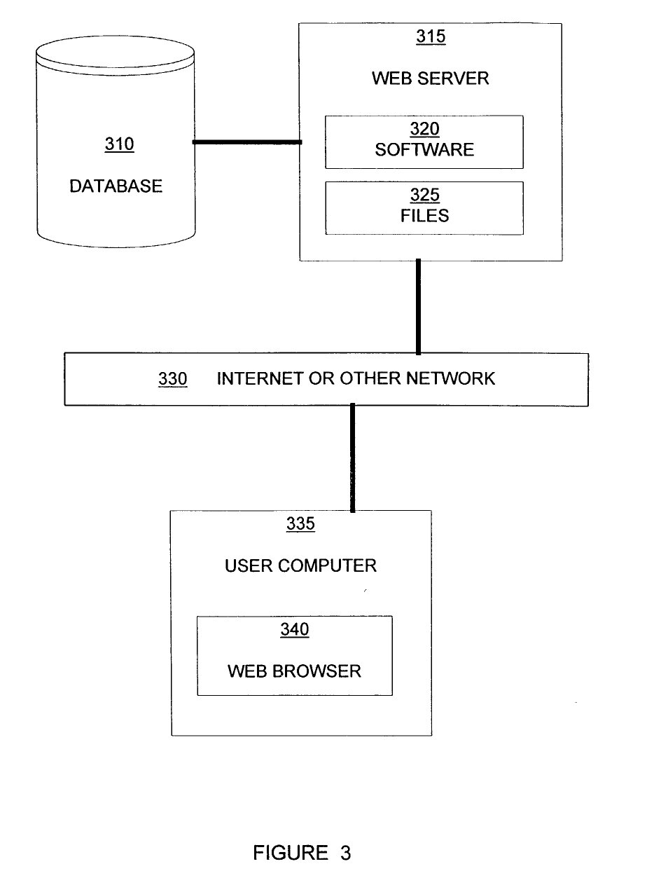

The present invention is a system for accessing content. Throughout the drawings, an attempt has been made to label corresponding elements with the same reference numbers. Referring to the drawings, FIG. 3 shows a simplified block diagram of one embodiment of the technical architecture for the present invention. As the figure shows, the user accesses the system through a user computer 335 connected to the Internet or other network 330. The user computer 335 includes a web browser 340, which sends requests over the Internet 330 to the web server 315. The web server includes software 320 and files 325 (such as HTML files) and is connected to one or more databases 310 storing data concerning the various users, employers, and benefits plans. As is well known in the art, the web server serves web pages to the web browser 340 in response to the requests.

The website, consisting of a series of webpages, which is served by the web server 315, provides various functions, including allowing the user to enroll in their plans, to review their coverage, to find out the status of pending claims, to track their deductibles, to find providers affiliated with their plan, to research health topics of interest to them from the website, and to access an online pharmacy for prescription drugs covered by the user's benefit plan.

Referring to the Appendix attached herewith, page 97 shows one embodiment of the homepage for a website of the present invention. Through this homepage, the user can login as a registered user. Users that are employees can access their personal accounts via the homepage. Consultants and brokers have access to other information, as do employers and providers.

From the foregoing detailed description, it will be evident that there are a number of changes, adaptations and modifications of the present invention which come within the province of those skilled in the art. However, it is intended that all such variations not departing from the spirit of the invention be considered as within the scope thereof.

Page 107 of the Appendix shows one embodiment of the present invention's registration process. Here, the user/employee is required to enter his or her PIN, first name, last name, email address, date of birth, and social security number. This data is used to authenticate the user and can result in the user being given a user ID for future website visits. Appendix page 109 shows one embodiment of the login function, whereby the user must enter his or her user ID and proper password. Once the user is logged in, page 110 illustrates one embodiment of the main web page for the user. The web page includes regions entitled: my^{tools}, my^{plan}, my^{headlines}, my^{mailbox}, my^{messages}, and my^{resources}. The my^{plan} section presents to the user content that is personalized through a two-tier system. First, the my^{plan} section contains information related specifically to the benefits package offered by the user's employer. Second, the information is further personalized to show data related to the specific benefits elections chosen by the user from the benefits package.

For example, suppose the employer Generic Corp. has contracted with various health care organizations to offer three health care plans: STANDARD CARE, SILVER CARE, and GOLD CARE. Generic Corp. may also choose to offer two types of dental insurance plans, known as GOOD TEETH and GREAT TEETH. These five plans make up the employer's benefits package Each employee of Generic Corp. chooses a combination of coverage among the various packages. For example, one manager may choose to have his entire family covered under the SILVER CARE and GOOD TEETH plans. A second manager at the company may choose to have single coverage under the GOLD CARE plan, but not to have any dental coverage. The combination of choices make up each employee's benefit elections. Of course, this is a overly simplified example. Benefits packages usually contain more components.

From this example, whenever one of the two managers log into the system, they will see under the my^{plan} section, information that has been selected from the database 310 based both on the employee's elections as well as the employer's offerings. The present invention also provides up-to-date information concerning the deductibles under the plans, the required co-pays, current and past claims for the user, etc.

In one embodiment of the present invention, the my^{plan} section includes information about plans being administrated by the administrator as well as links to plans that are not administered by the administrator. Thus, even though the administrator may focus solely on health care and insurance administration, links to the employee's 401 (k) provider and pension fund allow the user to view the present invention as a “one-stop shop” for his or her benefit needs.

Pages 112 and 140 of the Appendix shows that the registered user can communicate with a customer service representative via secure e-mail. The present invention generates a dynamic profile of the user based on the login ID and password. This dynamic profile allows the user to send the e-mail to the customer support representative without the need to provide his or her user ID, password, or information about which plans have been elected. The customer service representative receives all such pertinent information from the system through the dynamic profile. In one embodiment, the profile is generated at the front-end, when the user logs in. In another embodiment, the profile is generated at the back-end, when the customer service representative receives the e-mail message.

The profile is dynamic because is changes to conform to the user's status. For example, if the user uses the present invention to change health care elections, the profile is updated and the database 310 is updated either immediately or at the end of the user transaction.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for presenting personalized content to a user of a website, comprising:
accepting a login identifier from the user;
querying a database for a first set of content, wherein the first set of content is a function of the login identifier;
querying the database for a second set of content, wherein the second set of content is a function of the employer for which the user is employed; and
displaying the first set of content and the second set of content to the user through a web browser.

2. The method for presenting personalized content from claim 1, wherein the first set of content is information on the benefits election for the user.

3. The method for presenting personalized content from claim 1, wherein the second set of content is information on the benefits package of the employer.

4. The method for presenting personalized content from claim 1, further comprising:
displaying to the user a third set of content;
wherein the first set of content and the second set of content is information on plans administrated by a plan administrator controlling the website; and
wherein the third set of content is information on plans not administered by the plan administrator.

5. The method for presenting personalized content from claim 1, wherein the first set of content and the second set of content are used to generate a dynamic webpage.

6. The method for presenting personalized content from claim 5, wherein the dynamic webpage aggregates information from various sources.

7. The method for presenting personalized content from claim 1, further comprising:
generating a dynamic profile based on the login identifier; and
sending a secure email message from the user to a customer support representative, wherein data from the dynamic profile is available to the customer support representative.

8. The method for presenting personalized content from claim 7, wherein the secure email message is sent to the customer support representative without requiring the user to provide authenticating data.
